(19) United States
(12) Patent Application Publication
(10) Pub. No.: US 2024/0411673 A1
(43) Pub. Date: Dec. 12, 2024

(54) SYSTEMS AND METHODS FOR GENERATIVE AI BEHAVIOUR-DRIVEN DEVELOPMENT

(71) Applicant: LNRS Data Services Inc., Alpharetta, GA (US)

(72) Inventor: Oli Deakin, Southampton (GB)

(21) Appl. No.: 18/637,867

(22) Filed: Apr. 17, 2024

Related U.S. Application Data
(60) Provisional application No. 63/507,652, filed on Jun. 12, 2023.

(51) Int. Cl. G06F 11/36; G06N 3/0475

(52) U.S. Cl. CPC G06F 11/3688; G06F 11/3684; G06N 3/0475

(57) ABSTRACT

Behaviour Driven Development (BDD) is used to define test scenarios and to write the test scenarios in code first before writing the application code. Expected behaviours of the new functionality in natural language are defined and converted into test code driven by a Domain Specific Language (DSL) that encapsulates the description of the expected behaviour, after which code for the functionality can start to be written. In certain implementations, artificial intelligence (AI) may be used to first generate the test scenarios and relevant test data, then to produce code that passes all the tests (or iterates until it does) such that the code requires zero or nearly zero human inspection. If generated code passes the test scenarios, it meets the expected behaviour. This saves substantial time investment and reduces the number of steps to completion.

### CROSS-REFERENCE TO RELATED APPLICATIONS

This application claims priority under 35 U.S.C. 119 to U.S. Provisional Patent Application No. 63/507,652 entitled “Systems and Methods for Generative AI Behaviour-Driven Development,” filed 12 Jun. 2023, the contents of which are incorporated by reference in their entirety as if fully set forth herein.

### FIELD

The disclosed technology generally relates to accelerating a software development process using Generative Artificial Intelligence (AI).

### BACKGROUND

Artificial intelligence and/or machine language (AI/ML) services presents tremendous opportunities for businesses to streamline internal operations, build new products, and/or provide efficient service for customers. AI capabilities in services such as Github Copilot and/or ChatGPT can be used to generate source code to implement certain functionality based on natural language input that describes the desired functionality.

While useful and certainly accelerative to the development lifecycle, there are flaws in the traditional use of the traditional AI code-generation process that can hinder its effectiveness. For example, traditional AI models are trained on code written by humans, which will have code bugs and can result in the generated code output by the AI being similarly buggy. This problem is similar to the concept of bias in that inherent unfairness/incorrectness in the source training material becomes baked into the AI model. As a result, this code (like any human-written code) cannot be trusted and must be both reviewed and tested by humans. However, the testing of such code often takes as long or longer than writing the code itself, which means the majority of the work of creating code does not take full advantage of the Generative AI since testing must still be implemented.

In data-driven businesses, much testing will revolve around data-driven use cases. That is, when a given set of data is input, an expected set of data is output, thus describing (through enough input/output test cases) the expected behaviour of the module or system under test. This is time-consuming work for humans to perform, as crafting good input and output data sets requires careful exploration and curation of data to drive the desired code behaviour.

FIG. 1 depicts a general traditional process for using Generative AI to implement source code, review the source code, iterate to meet expectation, create curated data-driven test scenarios, implement test source code manually based on a scenario, and modify the source code to meet the expectations. In this traditional process, only the first or second steps are accelerated by the use of AI.

There is a need for a process and system that will allow creating and/or fine-tuning a AI/ML model using Generative AI to accelerate code generation.

### BRIEF SUMMARY

Some or all of the above needs may be addressed by certain embodiments of the disclosed technology. Certain embodiments of the disclosed technology may include pre-defining test scenarios and/or expectations in code first before writing the application code to pass the test scenarios. Certain exemplary implementations may maximally use the power of Generative AI to accelerate certain functions associated with the model generation, training, and/or verification.

In certain implementations, a method is provided for accelerating a software development process using Generative Artificial Intelligence (AI) and Behaviour Driven Development (BDD). The method can include receiving a natural language description of expected behaviors of machine-readable code functionality, converting the natural language description into test scenarios using a Domain Specific Language (DSL), submitting the test scenarios to a Generative AI to generate test code for executing the scenarios, generating data sets for the test scenarios using Generative AI based on the natural language description of expected behaviors, incorporating the generated data sets into the test scenario descriptions, generating implementation source code based on the generated test scenarios, and verifying the generated implementation source code.

In certain implementations, a system is disclosed for accelerating a software development process using Generative AI. The system can include a user interface for receiving a natural language description of expected behaviors of machine-readable code functionality, a converter module configured to convert the natural language description into test scenarios using a Domain Specific Language (DSL), a Generative AI module configured to generate test code based on the test scenarios and generate data sets based on the expected behavior description, an implementation code generation module configured to generate implementation source code based on the generated test scenarios, and a verification module for testing the generated implementation source code against the generated test scenarios.

In certain implementations, a computer-readable storage medium is provided for storing instructions that, when executed by a processor, cause the processor to perform the method of receiving a natural language description of expected behaviors of machine-readable code functionality, converting the natural language description into test scenarios using a Domain Specific Language (DSL), submitting the test scenarios to a Generative AI to generate test code for executing the scenarios, generating data sets for the test scenarios using Generative AI based on the natural language description of expected behaviors, incorporating the generated data sets into the test scenario descriptions, generating implementation source code based on the generated test scenarios, and verifying the generated implementation source code.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a block diagram of a standard Generative AI process for generating source code.

FIG. 2 is an illustrative example of a behaviour driven development (BDD) test scenario.

FIG. 3 depicts an example process, according to certain exemplary implementations of the disclosed technology.

FIG. 4 is a block diagram of an illustrative computing system, according to an exemplary embodiment of the disclosed technology.

FIG. 5 is a flow diagram of a method according to an exemplary embodiment of the disclosed technology.

### DETAILED DESCRIPTION

Embodiments of the disclosed technology will be described more fully hereinafter with reference to the accompanying drawings, in which certain example embodiments are shown. This disclosed technology may, however, be embodied in many different forms and should not be construed as limited to the embodiments set forth herein; rather, these embodiments are provided so that this disclosure will be thorough and complete, and will fully convey the scope of the disclosed technology to those skilled in the art.

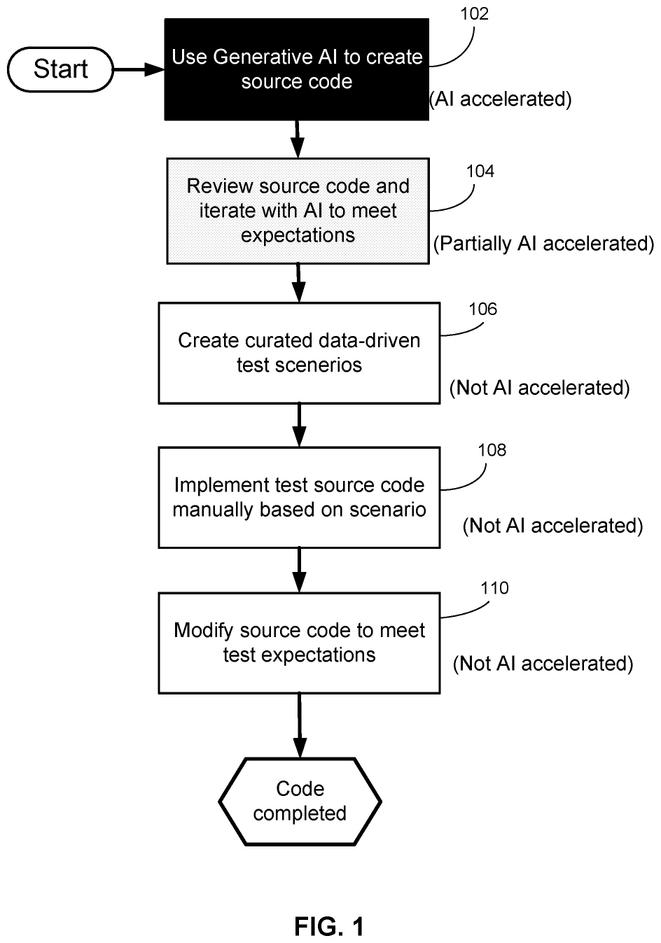

The disclosed technology can provide an alternative to the traditional time-consuming process of using Generative AI to implement source code, which is depicted in FIG. 1. In a first step 102 of the traditional process, Generative AI may be uses to create source code. In a second step 104, and in certain cases, the generated source code can be reviewed and/or iterated with AI to determine if the generated source code meets expectations. However, in the traditional process, the third step 106 (creating curated data-driven test scenarios), the fourth step 108 (manually implementing test source code based on the scenario), and/or fifth step 110 (modifying the source code to meet test expectations) are manually performed without the use of AI to accelerate the process.

Certain implementations of the disclosed technology can improve the development speed, accuracy, and reliability of the traditional process outlined above to enable the use of AI in creating test scenarios, writing test code, and writing feature code to pass the tests, as will be discussed below. Certain implementations of the disclosed technology may be utilized to fine-tune AI/ML model(s) using Generative AI to accelerate code generation.

Certain implementations of the disclosed technology may utilize Behaviour Driven Development (BDD) that can be considered an extension of Test-Driven Development, which is a methodology that focuses on defining test scenarios and writing them in code first before writing the application code to pass them. The disclosed technology can provide an efficient process that can maximally use the power of Generative AI.

A Domain Specific Language (DSL) is a computer language that is typically targeted to a particular kind of problem, in contrast to a general-purpose computer language. For example, HTML is a typical DSL for web activity; SQL is a DSL for data management; Verilog is a DSL for hardware, etc. In BDD, it is typical for a Product Owner (or other customer-facing role) to work with engineering teams to define expected behaviours of the new functionality in natural language. Expected behaviours are then converted into test code by developers, potentially driven by a DSL that encapsulates the Product Owner's description, after which code for the functionality can start to be written to pass the test.

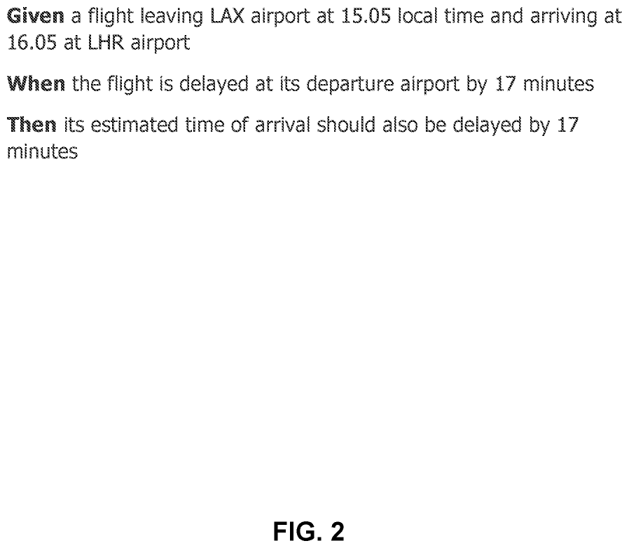

FIG. 2 provides an example of a defined expected behavior written as a Given . . . , When . . . , Then . . . statement. For example:
Given a flight leaving LAX airport at 15.05 local time and arriving at 16.05 at LHR airport
When the flight is delayed at its departure airport by 17 minutes
Then its estimated time of arrival should also be delayed by 17 minutes

Writing such test scenarios with expected behavior in natural language is well-suited for submission to Generative AI to create the necessary test code to then execute the scenarios from the DSL description. A human may still need to review the code and iterate with the AI (as is the case with any Generative AI code output), but the disclosed technology may still offer a substantial acceleration of this step of the process.

Additionally, in a data-driven business where data inputs and outputs for behaviour test scenarios may be much more complex, certain implementations of the disclosed technology may utilize Generative AI to create the necessary data sets for the test. These data sets can then be added to the test scenarios/expected behaviour sets. In certain implementations, scenario descriptions for the AI may be incorporated into the test implementation it creates, which can offer a substantial acceleration of this step of the process.

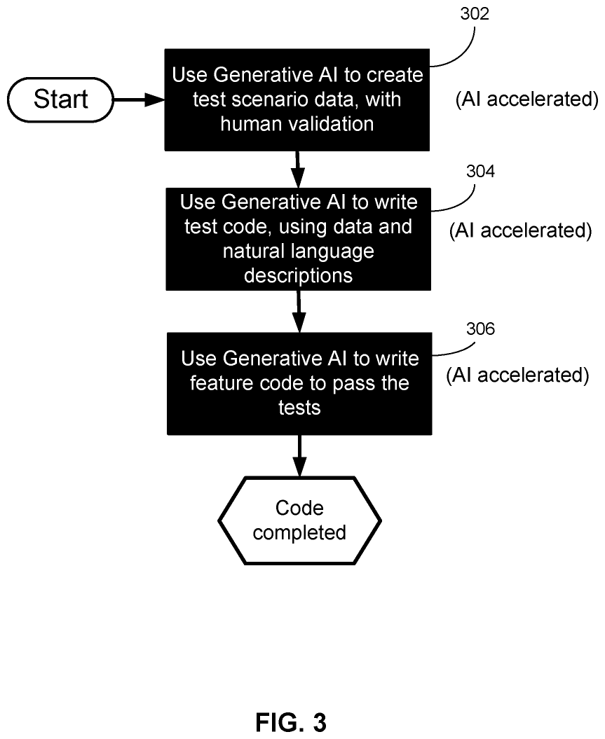

FIG. 3 depicts an example process, according to certain exemplary implementations of the disclosed technology, in which each of the steps may be accelerated with AI. In comparison to the traditional method illustrated in the flow-chart of FIG. 1, the process of the disclosed technology shown in FIG. 3 may utilize AI to generate implementation source code based on (validated) AI generated test scenario data, and feature code may also be AI-generated so that the source code will pass all of the tests.

In the first step 302 FIG. 3, Generative AI may be utilized to generate full test scenarios. In the second step 304, Generative AI may be used to write test code for testing the generated test scenarios. In this step, data and natural language descriptions may be utilized as input to the AI for generation of the test code. In the third step 306, AI may be utilized to write feature implementation code that will pass all the tests. Thus, in contrast to traditional approaches in which code can be written based on inaccurate human statements, the disclosed technology enables AI to write code without exposing the process to human statements that have room for inaccuracy.

Certain implementations may model the expected behaviours in test scenarios, and as long as the AI produces code that passes all the tests (or iterate with it until it does, which could be automated) then the code may require zero or nearly zero human inspection. If the generated code passes the tests, it meets the expected behaviour. Thus, implementations of the disclosed technology can save substantial time investment and can reduce the number of steps to completing bug-free source code generation.

### Example Use Case:

In an example use case, a developer may use the disclosed technology and may follow the principles of Behaviour Driven Development to generate test scenarios and proven code, as illustrated in FIG. 3. In the first step 302, generative AI may be used to create test scenario data. The developer may use the disclosed technology, for example, to write a function in Java that will take as input, an International Air Transport Association (IATA) and/or International Civil Aviation Organization (ICAO) short-code and return the name of the relevant airline for presentation in a user interface. For example, a dataset that contains the relevant data may be input to the AI model. In this case, the input data may be a mapping between IATA codes, ICAO codes and airline names. For this example use case, Table 1 shows simple data input that may be used to illustrate this step:

### Table 1

IATA ICAO Airline name
BA BAW British Airways
LS EXS Jet2.com
LH DLH Lufthansa
MH MAS Malaysia Airlines
VS VIR Virgin Atlantic

Then the AI could be instructed to: “Create some test scenarios, both positive and negative with this data for a Java function that takes an ICAO and/or IATA code and returns an airline name, and outputs a table of the inputs and expected outputs for such a function.”

In this example, the AI may return scenarios and the tabulated test data that can be used in automated testing, as follows:

### Positive Test Scenarios:

1. Input: “BAB”. Expected output: “British Airways”.
2. Input: “LSE”. Expected output: “Jet2.com”.
3. Input: “LHD”. Expected output: “Lufthansa”.

### Negative Test Scenarios:

1. Input: “XYZ”. Expected output: null (no matching airline).
2. Input: “ ”. Expected output: null (empty input).
3. Input: “MHMASVSVIR”. Expected output: null (multiple matching airlines).

### Table of Inputs and Expected Outputs:

   |Code|Airline name|
   |-|-|
   |BAB|British Airways|
   |LSE|Jet2.com|
   |LHD|Lufthansa|
   |XYZ|-|
   |-|-|
   |MHMASVSVIR|-|

### Notes:

In the table, “-” represents no matching airline or empty input.
The provided context does not specify if there are any constraints or rules for the inputs or desired behavior in case of errors, so the above assumptions have been made based on common practices in similar scenarios.
If further details or requirements are provided, the test scenarios and table can be adjusted accordingly.

The AI may then be instructed to restate these scenarios as GIVEN . . . WHEN . . . THEN . . . behavioral scenarios by the instruction: “Restate the earlier test scenarios as GIVEN . . . WHEN . . . THEN . . . statements.” The AI may output the following in response:

Here are the earlier provided test scenarios restated in the “Given-When-Then” format:

### Positive Scenarios:

1. GIVEN that the IATA/ICAO code is “BAB”, WHEN the function ‘getAirlineName’ is invoked with this code, THEN it should return “British Airways”.
2. GIVEN that the IATA/ICAO code is “LSE”, WHEN the function ‘getAirlineName’ is invoked with this code, THEN it should return “Jet2.com”.
3. GIVEN that the IATA/ICAO code is “LHD”, WHEN the function ‘getAirlineName’ is invoked with this code, THEN it should return “Lufthansa”.

### Negative Scenarios:

1. GIVEN that the IATA/ICAO code is “XYZ”, WHEN the function ‘getAirlineName’ is invoked with this code, THEN it should return null as there is no matching airline for this code.
2. GIVEN that the IATA/ICAO code is an empty string, WHEN the function ‘getAirlineName’ is invoked with this code, THEN it should return null as it's an invalid input.
3. GIVEN that the IATA/ICAO code is “MHMASVSVIR”, WHEN the function ‘getAirlineName’ is invoked with this code, THEN it should return null as this code does not match with a single airline.

The result to this point in the example use case is that scenario definitions and input data with expected outputs are generated, which completes step 1 302 of FIG. 3.

In step 2 304 of FIG. 3, generative AI may be used to write test code using data and natural language descriptions. Continuing the example use case, The AI may be instructed to implement data-driven test cases that use the previously generated data to test the function previously described using the following input: “In Java code and using Junit framework, write unit tests for the above scenarios that provide the inputs to the function and verify the return string is what is expected.” In response, the AI may return source code implementations of the test cases it previously described from the source data set and natural language description of the function. An example is shown below based on the scenario being used here.
import org.junit.Test;
import static org.junit.Assert.assertEquals;
public class AirlineTests
   {
   @test
   public void testBritishAirwaysIATACode( )
      {
      String iataCode=“BA”;
      String expectedName=“British Airways”;
      String actualName=getAirlineName(iataCode);
      assertEquals(expectedName, actualName);
      }
   // Add more similar methods for other scenarios . . . .
   }

Human validation of the generated scenarios may be applied here and iterated upon with the AI, but almost all the work is done by the AI itself. The creation of the test data and the test scenarios completes step 2 304 of FIG. 3.

In step 3 306 of FIG. 3, generative AI may be used to write feature code to pass the tests. In the example scenario, the AI can now be instructed to generate the code to pass the tests using the following instructions: “From the test scenarios that have been described above, write implementation code for the Java function under test that will pass all those tests.”

The AI may then write code based on the previous test scenarios that is capable of passing them all. For example, shown below is a very simplified implementation-a real one may read data from a database etc., all of which may be driven by descriptions of the test scenario behaviour in previous steps before reaching this implementation:
import java.util.HashMap;
import java.util.Map;
public class AirlineUtils
{
   private static Map<String, String> airlineNames;
   static
   {
   //Initialize and populate the list of airlines
   airlineNames=new HashMap< >( )
   airlineNames.put(“BAB”, “British Airways”);
   airlineNames.put(“LSE”, “let2.com”);
   airlineNames.put(“LHD”, “Lufthansa”);
   // Add more airline IATA/ICAO and respective names here
   }
/**
* This method accepts IATA/ICAO airline code as input and returns the airline name.
* @param_ataIcaoCode IATA or ICAO code for an airline
* @return the name of airline or null if airline code doesn't exist
*/
public static String getAirlineName(String iataIcaoCode)
   {
   return airlineNames.get(iataIcaoCode);
      }
}

The generated code in the above example completes step 3 306 of FIG. 3, and the developer has a full set of test scenarios and proven code, following the principles of Behaviour Driven Development (BDD).

As illustrated in the example use case above, certain implementations of the disclosed technology may be utilized to generate test data via natural language queries to an AI attached to a test or production data repository. The AI may be used to generate test input and output data sets in test-friendly structured formats to drive behaviours rather than answer direct questions.

Further as illustrated in the example use case, certain implementations of the disclosed technology may be utilized generate test scenario code from the test input and output data sets and functional behaviour descriptions in natural language to generate BDD-style test code from the given data and descriptions.

As illustrated in the example use case, certain implementations of the disclosed technology may utilize the test data and scenario code to generate final implementation code. In certain implementations, assuming the final implementation code passes the test scenario(s), such generation can be done without the need of human intervention.

Certain implementation of the disclosed technology may provide improvements over traditional systems. In accordance with certain implementations, Generative AI may be utilized for the end-to-end BDD process, which can provide a technical benefit of reducing man-hours and/or time and effort in code generation. For example, by generating test data and code and using that output to generate functionally accurate code as a following stage result in a significant acceleration in the process of code generation.

Various implementations of the communication systems and methods herein may be embodied in non-transitory computer readable media for execution by a processor. An example implementation may be used in an application of a mobile computing device, such as a smartphone or tablet, but other computing devices may also be used, such as to portable computers, tablet PCs, Internet tablets, PDAs, ultra mobile PCs (UMPCs), etc.

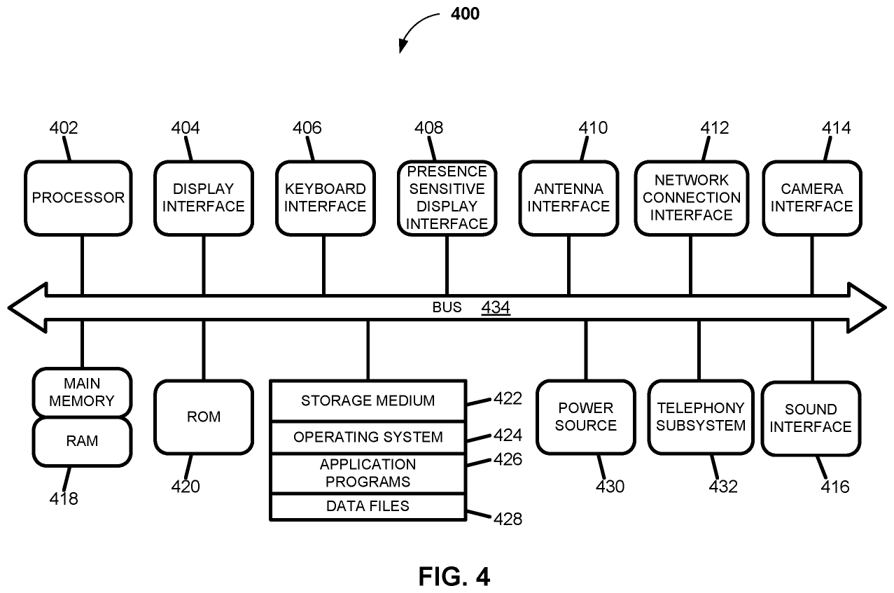

FIG. 4 depicts a block diagram of an illustrative computing device 400 that may be utilized to enable certain aspects of the disclosed technology. Various implementations and methods herein may be embodied in non-transitory computer-readable media for execution by a processor. It will be understood that the computing device 400 is provided for example purposes only and does not limit the scope of the various implementations of the communication systems and methods.

The computing device 400 of FIG. 4 includes one or more processors where computer instructions are processed. The computing device 400 may comprise the processor 402, or it may be combined with one or more additional components shown in FIG. 4. In some instances, a computing device may be a processor, controller, or central processing unit (CPU). In yet other instances, a computing device may be a set of hardware components.

The computing device 400 may include a display interface 404 that acts as a communication interface and provides functions for rendering video, graphics, images, and texts on the display. In certain example implementations of the disclosed technology, the display interface 404 may be directly connected to a local display. In another example implementation, the display interface 404 may be configured for providing data, images, and other information for an external/remote display. In certain example implementations, the display interface 404 may wirelessly communicate, for example, via a Wi-Fi channel or other available network connection interface 412 to the external/remote display.

In an example implementation, the network connection interface 412 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 404 may be operatively coupled to a local display. In another example, the display interface 404 may wirelessly communicate, for example, via the network connection interface 412 such as a Wi-Fi transceiver to the external/remote display.

The computing device 400 may include a keyboard interface 406 that provides a communication interface to a keyboard. According to certain example implementations of the disclosed technology, the presence-sensitive display interface 408 may provide a communication interface to various devices such as a pointing device, a touch screen, etc.

The computing device 400 may be configured to use an input device via one or more of the input/output interfaces (for example, the keyboard interface 406, the display interface 404, the presence-sensitive display interface 408, the network connection interface 412, camera interface 414, sound interface 416, etc.) to allow a user to capture information into the computing device 400. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 400 or may be a separate device. For example, the input device may be an accelerometer, a magnetometer, a digital camera, a microphone, and an optical sensor.

Example implementations of the computing device 400 may include an antenna interface 410 that provides a communication interface to an antenna; a network connection interface 412 that provides a communication interface to a network. According to certain example implementations, the antenna interface 410 may be utilized to communicate with a Bluetooth transceiver.

In certain implementations, a camera interface 414 may be provided that acts as a communication interface and provides functions for capturing digital images from a camera. In certain implementations, a sound interface 416 is provided as a communication interface for converting sound into electrical signals using a microphone and for converting electrical signals into sound using a speaker. According to example implementations, random-access memory (RAM) 418 is provided, where computer instructions and data may be stored in a volatile memory device for processing by the CPU 402.

According to an example implementation, the computing device 400 includes a read-only memory (ROM) 420 where invariant low-level system code or data for basic system functions such as basic input and output (I/O), startup, or reception of keystrokes from a keyboard are stored in a non-volatile memory device. According to an example implementation, the computing device 400 includes a storage medium 422 or other suitable types of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 (including, for example, a web browser application, a widget or gadget engine, and or other applications, as necessary) and data files 428 are stored. According to an example implementation, the computing device 400 includes a power source 430 that provides an appropriate alternating current (AC) or direct current (DC) to power components. According to an example implementation, the computing device 400 includes a telephony subsystem 432 that allows the device 400 to transmit and receive sound over a telephone network. The constituent devices and the CPU 402 communicate with each other over a bus 434.

In accordance with an example implementation, the CPU 402 has an appropriate structure to be a computer processor. In one arrangement, the computer CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 to execute software programs. Data may be stored in the RAM 418, where the data may be accessed by the computer CPU 402 during execution. In one example configuration, the device 400 includes at least 128 MB of RAM, and 256 MB of flash memory.

The storage medium 422 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 400 to access computer-executable process steps, application programs, and the like, stored on removable and non-removable memory media, to off-load data from the device 400 or to upload data onto the device 400. A computer program product, such as one utilizing a communication system may be tangibly embodied in storage medium 422, which may comprise a machine-readable storage medium.

According to one example implementation, the term computing device, as used herein, may be a CPU, or conceptualized as a CPU (for example, the CPU 402 of FIG. 4). In this example implementation, the computing device (CPU) may be coupled, connected, and/or in communication with one or more peripheral devices.

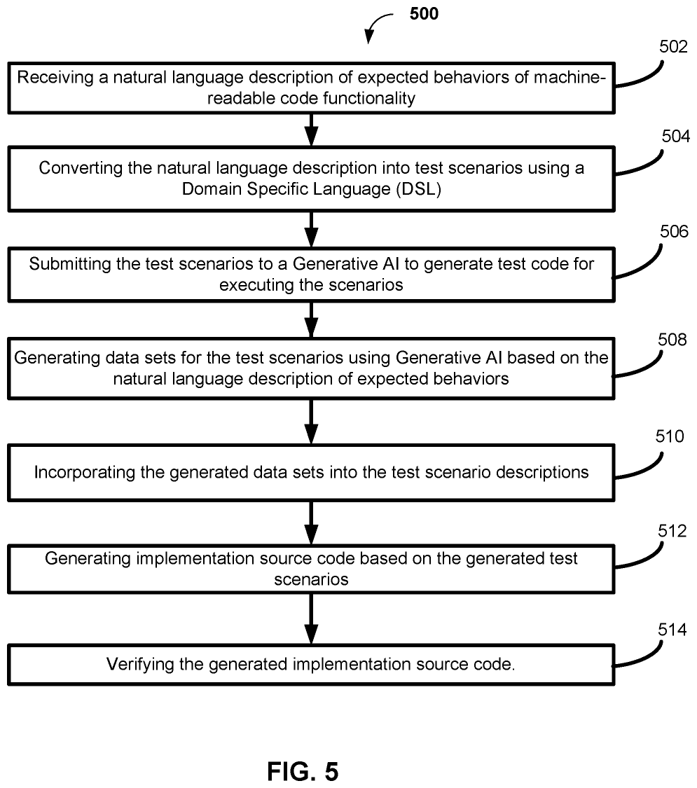

An exemplary method 500 for accelerating a software development process using Generative Artificial Intelligence (AI) and Behaviour Driven Development (BDD) will now be described with reference to the flowchart of FIG. 5. The method 500 starts in block 502, and according to an exemplary embodiment of the disclosed technology includes receiving a natural language description of expected behaviors of machine-readable code functionality. In block 504, the method 500 includes converting the natural language description into test scenarios using a Domain Specific Language (DSL). In block 506, the method 500 includes submitting the test scenarios to a Generative AI to generate test code for executing the scenarios. In block 508, the method 500 includes generating data sets for the test scenarios using Generative AI based on the natural language description of expected behaviours. In block 510, the method 500 includes incorporating the generated data sets into the test scenario descriptions. In block 512, the method 500 includes generating implementation source code based on the generated test scenarios. In block 514, the method 500 includes verifying the generated implementation source code.

In certain implementations, the Generative AI may be trained to generate test code and data sets based on the expected behaviors described in the natural language description.

In certain implementations, the Generative AI may utilize machine learning techniques to improve the quality and accuracy of the generated test code and data sets over time.

In certain implementations, the natural language description of expected behaviors description may be based on product information.

In certain implementations, the natural language description of expected behaviors description may be based on customer information.

Some implementations can include reviewing the generated test code to ensure requirement compliance.

In accordance with certain implementations, the source code may be generated without human intervention.

In certain implementations, verifying the generated implementation source code can include utilizing one or more tests to determine the accuracy of the source code output.

In certain implementations, the generated code may be validated for security, privacy, and performance before being executed.

In certain implementations, the generated code may be validated to ensure it meets acceptable standards.

Certain embodiments of the disclosed technology may include any number of hardware and/or software applications that are executed to facilitate any of the operations. In exemplary embodiments, one or more I/O interfaces may facilitate communication between the input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, embodiments of the disclosed technology may include more or less of the components illustrated in FIG. 4.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

In the preceding description, numerous specific details are set forth. However, it is to be understood that embodiments may be practiced without these specific details. In other instances, well-known methods, structures and techniques have not been shown in detail in order not to obscure an understanding of this description. The term “exemplary” herein is used synonymous with the term “example” and is not meant to indicate excellent or best. References to “one embodiment,” “an embodiment,” “exemplary embodiment,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

This written description uses examples to disclose certain embodiments of the disclosed technology, including the best mode, and to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed disclosed technology is:

1. A method for accelerating a software development process using Generative Artificial Intelligence (AI) and Behaviour Driven Development (BDD), the method comprising:
receiving a natural language description of expected behaviors of machine-readable code functionality;
converting the natural language description into test scenarios using a Domain Specific Language (DSL);
submitting the test scenarios to a Generative AI to generate test code for executing the test scenarios;
generating data sets for the test scenarios using Generative AI based on the natural language description of expected behaviours;
incorporating the generated data sets into descriptions of the test scenarios;
generating implementation source code based on the test scenarios; and
verifying the generated implementation source code.

2. The method of claim 1, wherein the Generative AI is trained to generate the test code and the data sets based on the expected behaviors described in the natural language description.

3. The method of claim 1, wherein the Generative AI utilizes machine learning techniques to improve quality and accuracy of the generated implementation source code and the data sets over time.

4. The method of claim 1, wherein the natural language description of expected behaviors description is based on product information.

5. The method of claim 1, wherein the natural language description of expected behaviors description is based on customer information.

6. The method of claim 1, further comprising reviewing the generated implementation source code to ensure requirement compliance.

7. The method of claim 1, wherein the implementation source code is generated without human intervention.

8. The method of claim 1, wherein verifying the generated implementation source code comprises utilizing one or more tests to determine an accuracy of.

9. A system for accelerating a software development process using Generative AI, the system comprising:
a user interface for receiving a natural language description of expected behaviors of machine-readable code functionality;
a converter module configured to convert the natural language description into test scenarios using a Domain Specific Language (DSL);
a Generative AI module configured to generate test code based on the test scenarios and generate data sets based on a description of expected behavior;
an implementation code generation module configured to generate implementation source code based on the test scenarios; and
a verification module for testing the generated implementation source code against the test scenarios.

10. The system of claim 9, wherein the Generative AI module comprises a machine learning model trained on a dataset of natural language descriptions and corresponding test code and the data sets.

11. The system of claim 9, wherein the implementation code generation module utilizes the test scenarios as functional specifications to generate the implementation source code.

12. The system of claim 9, wherein the verification module automates the testing of the generated implementation source code against the test scenarios.

13. The system of claim 9, further comprising a feedback module for providing feedback to the Generative AI module based on results output by the verification module to improve quality and accuracy of the generated implementation source code and the data sets.

14. The system of claim 9, further comprising a review module for review and iteration with the Generative AI for the generated implementation source code and the data sets.

15. The system of claim 9, further comprising a repeat module for repeating review, iteration, and verification until the generated implementation source code passes all tests according to a predetermined metric.

16. The system of claim 9, further comprising a code inspection module for determining a need for additional inspection based on an output of the verification module.

17. The system of claim 9, further comprising a completion module for indicating a completion when the generated implementation source code requires zero or nearly zero human inspection and passes all tests according to a predetermined metric.

18. A computer-readable storage medium storing instructions that, when executed by a processor, cause the processor to perform a method of:
receiving a natural language description of expected behaviors of machine-readable code functionality;
converting the natural language description into test scenarios using a Domain Specific Language (DSL);
submitting the test scenarios to a Generative AI to generate test code for executing the test scenarios;
generating data sets for the test scenarios using Generative AI based on the natural language description of expected behaviours;
incorporating the generated data sets into test scenario descriptions;
generating implementation source code based on the test scenarios; and
verifying the generated implementation source code.

19. The computer-readable storage medium of claim 18, wherein the implementation source code is generated without human intervention.

20. The computer-readable storage medium of claim 18, wherein verifying the generated implementation source code comprises utilizing one or more tests to determine an accuracy of the implementation source code.
